(19) United States
(12) Patent Application Publication
(10) Pub. No.: US 2025/0382210 A1
(43) Pub. Date: Dec. 18, 2025

(54) SYSTEMS AND METHODS FOR FILTERING WATER

(71) Applicant: Whitaferd LLC, Concord, MA (US)

(72) Inventor: Kurt Josef Seifert, Vienna, VA (US)

(21) Appl. No.: 19/237,551

(22) Filed: Jun. 13, 2025

Related U.S. Application Data
(60) Provisional application No. 63/660,889, filed on Jun. 17, 2024.

(51) Int. Cl. C02F 3/32; C02F 1/00; C02F 101/10; C02F 101/16

(52) U.S. Cl. CPC C02F 3/327; C02F 1/001; C02F 2101/105; C02F 2101/16; C02F 2203/006; C02F 2209/02; C02F 2209/40

(57) ABSTRACT

Systems and methods are providing for filtering a body of water, such as a lake, ocean, river or the like. A system comprises a housing having an interior configured for containing a plurality of bivalves within the water and a fluid distribution system coupled to the housing and configured to circulate water within the interior of the housing such that the water is filtered by the bivalves at a rate of about 10 to about 100 gallons of water per day per bivalves. The system provides a controlled environment to allow bivalves, such as clams, oysters and scallops, to filter the water naturally and remove materials, such as sediment, nitrogen, phosphorus, carbon, magnesium, zinc and the like. Oysters may, for example, filter pollutants from the water, remove excess nitrogen from the water and/or remove carbon from the water, which reduces the overall amount of carbon that eventually ends up in the atmosphere.

### CROSS-REFERENCE TO RELATED APPLICATIONS

This application claims the benefit of U.S. Provisional Application Ser. No. 63/660,089, filed Jun. 14, 2024, the complete disclosure of which is incorporated herein by reference for all purposes.

### BACKGROUND

Oysters, claims and other bivalves are an integral part of marine ecosystems, serving as an ecosystem engineer and enhancing biodiversity by improving water quality. Natural oysters tend to attach to reefs, rocks, barnacles, old oyster shells, and other hard substances in the ocean that contain calcium carbonate. The calcium carbonate is used by the oyster to form and grow their shells.

Nitrogen is an essential nutrient for plants and animals, but too much nitrogen—often from fertilizer runoff and septic tanks—boosts the growth of algae, which overwhelm water bodies and ultimately reduce oxygen levels in them. Oysters, clams, and other shellfish are efficient filter feeders that help remove excess nitrogen from waters by incorporating it into their shells and tissue as they grow. Oysters also filter these pollutants by consuming them or shaping them into small packets, which are deposited on the bottom of the sea where they are not harmful.

While filter feeding, adult oysters can each process one to two gallons of water per hour, during which they remove algae, plankton, and other particles that impact water clarity. Adult oysters, for example, reportedly can filter up to 50 gallons a day, while large quahogs (hard clams) can clean about 24 gallons of water a day. Oysters may also potentially mitigate the effects of nutrient pollution in coastal waters by fixing nitrogen and phosphorous in their shells, tissues and excrement.

The natural oyster and claim population, however, is in danger. Eighty five percent of their reefs have been destroyed due to rising temps and overfishing. The oysters in the Chesapeake Bay, for example could once filter a volume of water equal to that of the entire Bay (about 19 trillion gallons) in a week. Today, it would take the remaining Bay oysters more than a year.

In addition, an oyster's water filtration rate depends on a lot of environmental factors. For example, oysters don't feed much at very low temperatures and get stressed out at super high temperatures. Thus, oysters in colder waters, such as the eastern coast of Maine or Canada, may feed well during the summer months, but largely remain dormant and avoid feeding during the winter, reducing their effectiveness at filtering the ocean water in which they live. The temperature in warmer waters, such as the Chesapeake Bay and further south, is considered too hot for oysters to effectively feed, which results in smaller oysters that do not filter as much water during their lifetime.

Other factors such as salinity, turbidity, water circulation and the quantity and quality of food can also affect how much water oysters can, or will, filter. For example, certain kinds of harmful algae found in brown or red tides, can switch off an oyster's appetite.

It would therefore be desirable to provide an improved system and method of filtering nitrogen and other materials from large bodies of water with bivalves, such as oysters and clams. In particular, it would be desirable to provide systems and methods that carefully control the temperature, water circulation rate and/or other factors that influence the filtration rate of the oysters to increase the efficiency of each oyster.

### SUMMARY

Systems and methods are provided for filtering water, such as water sourced from an ocean, lake, river or the like. The systems and methods provide a controlled environment to allow bivalves, such as clams, oysters, scallops and the like, to filter the water naturally and remove certain materials from the water, such as sediment, nitrogen, phosphorus, carbon, magnesium, zinc and the like.

In one aspect, a system for filtering water comprises a housing having an interior configured for containing a plurality of bivalves within a fluid and a fluid distribution system coupled to the housing and configured to circulate water within the interior of the housing. The fluid distribution system is configured to circulate the water through the bivalves such that the water is filtered by the bivalves at a rate of about 10 to about 100 gallons of water per day per bivalve. The bivalves may, for example, filter pollutants from the water, remove excess nitrogen from the water and/or remove carbon from the water, which reduces the overall amount of carbon that eventually ends up in the atmosphere.

In embodiments, the bivalves comprise oysters and the water is filtered by the oysters at a rate of about 40 to about 60 gallons of water per day per oyster. The oysters filter sediment, nitrogen, phosphorus, carbon, magnesium, zinc and other minerals or contaminants from the water. In an exemplary embodiment, the oysters are triploid oysters, which typically grow faster, attain a larger size, and have a greater filtering capacity than standard diploid oysters.

In embodiments, the system further comprises a temperature control coupled to the housing and configured to maintain a temperature of the water within a predetermined range. Maintaining the temperature within a predetermined range optimizes the environment for the bivalves and increases their filtering capabilities. In one embodiment, for example, the bivalves are oysters and the temperature is maintained between about 60 degrees Fahrenheit to about 68 degrees Fahrenheit. This temperature range is optimal for oysters to continuously feed all year round, which increases their overall filtration capacities.

In certain embodiments, the temperature is controlled by moving water from a relatively warm natural body of water and through a colder environment and to the housing. In one such embodiment, the fluid distribution system includes a conduit in thermal contact with a natural thermal reservoir having a temperature cooler than the body of water. The conduit is configured to transfer energy from the water to the thermal reservoir to cool the water such that a temperature of the water is substantially reduced between the body of water and the housing. The system utilizes the colder temperature of nearby thermal reservoirs to cool the water and create a suitable environment for cultivating the bivalves so that the bivalve continuously filter the water.

In certain embodiments, the natural body of water is an inlet to an ocean, such as a bay, inlet, cove, gulf, estuary, basin, fjord or the like, that contains saltwater with a sufficient amount of nutrients to feed the oysters and is easily accessible for a land-based farming system. The bay may have average temperatures greater than about 80 degrees Fahrenheit. The relatively warm ocean water is pumped from the bay through the natural thermal reservoir until it is cooled to a suitable temperature for the oysters, preferably at least 10 degrees cooler than the water in the bay, and more preferably about 60 to 68 degrees Fahrenheit.

In one embodiment, the natural thermal reservoir is the earth and the conduit is configured to use the earth as a heat sink. The conduit preferably extends from the inlet below the surface of the earth to the housing and is configured to transfer a sufficient amount of energy from the water to the earth to cool the water to a temperature range suitable for the oysters. Specifically, the conduit is designed with an outer surface area and a length configured to transfer energy from the water to the earth and cool the water to the desired temperatures within the housing. In an exemplary embodiment, the conduit resides at a depth of at least 2 feet below the earth's surface, where the average temperature is typically around 54 degrees Fahrenheit.

In embodiments, the fluid distribution system further includes an outlet coupled to the housing and the body of water. The distribution system circulates the filtered water from the housing back into the body of water, e.g., an ocean, river or lake.

In embodiments, the system further comprises a control intake coupled to the inlet of the fluid distribution system for controlling a volumetric flow rate of the water into the conduit. This ensures that the system intakes a controlled volume of water from the natural body of water (e.g., an inlet to an ocean), to optimize the filtering capacity of the oysters. In addition, it ensures that the system is environmentally friendly and complies with relevant regulatory requirements. In an exemplary embodiment, the volumetric flow rate into the conduit is between about 0.005 to 0.50 feet per second, preferably about 0.15 to about 0.20 feet per second.

In certain embodiments, the control intake comprises a cage substantially surrounding the inlet of the conduit. The cage may include one or more filters configured to control the volumetric flow rate of the water into the conduit. The filters may include any suitable water filtration devices, such as mesh screens, or the like.

In an exemplary embodiment, the inlet comprises a pipe extending into the inlet of an ocean or similar body of water. The pipe includes a collar substantially surrounding a distal end portion of the pipe for anchoring the pipe within the body of water. The filters or mesh screens may, for example, be attached to pilings in the ocean to anchor the entire inlet and control intake system.

In certain embodiments, the system further comprises an oxygen delivery system coupled to the interior of the housing and configured to deliver oxygen into the fluid. The oxygen delivery system preferably delivers a sufficient amount of oxygen into the interior of the housing to increase a rate of circulation of the fluid. The oxygen increases the rate of circulation of the water which provides a constant source of nutrition to the oysters, thereby increasing their filtering capacity.

In a preferred embodiment, the oxygen delivery system comprises a pump coupled to a source of air, and a conduit fluidly coupling the source of air with the interior of the housing. The conduit may have one or more outlets in the interior of the housing to provide oxygen into the water and increase its rate of circulation through the oysters. The fluid distribution system may also include one or more propellers disposed within the interior of the housing to further increase circulation of the water. In an exemplary embodiment, the housing has a dividing wall extending through at least a portion of the interior of the housing and the fluid distribution system is configured to circulate the fluid around the dividing wall.

In another embodiment, the system comprises a substrate disposed within the interior of the housing adjacent to or near the oysters. The substrate has a surface configured for allowing the oysters to attach thereto. The substrate preferably comprises an inorganic material that includes calcium carbonate or other suitable materials that aid oysters to grow their shells. This allows the oysters to attach to the substrate and strengthen their shells so that the shells do not break apart when they are shucked. The substrate may comprise any suitable inorganic material, such as concrete, limestone, chalk or the like. In an exemplary embodiment, the housing comprises a plurality of concrete layers disposed between each of the casings to allow the juvenile oysters to attach to the concrete layers as they grow.

In another aspect, a method for filtering water from a body of water comprises positioning a plurality of bivalves within an interior of a housing and circulating the water through the bivalves such that the water is filtered by the bivalves at a rate of about 10 to about 100 gallons of water per day per oyster. In embodiments, the method further comprises circulating the filtered water from the housing and back to the body of water.

In embodiments, the bivalves comprise oysters and the water is filtered by the oysters at a rate of about 40 to about 60 gallons of water per day per oyster. The oysters filter sediment, nitrogen, phosphorus, carbon, magnesium, zinc and other minerals or contaminants from the water.

In embodiments, the method further comprises maintaining a temperature of the water within a predetermined range to optimize the environment for the bivalves and increase their filtering capabilities. In one embodiment, for example, the bivalves are oysters and the temperature is maintained between about 60 degrees Fahrenheit to about 68 degrees Fahrenheit. This temperature range is optimal for oysters to continuously feed all year round, which increases their filtration capacities.

In certain embodiments, the temperature is controlled by moving water from a relatively warm natural body of water to the housing. In these embodiments, the water may be moved through a conduit in thermal contact with a natural thermal reservoir having a temperature cooler than the body of water. The conduit transfers energy from the water to the thermal reservoir to cool the water such that a temperature of the water is substantially reduced between the body of water and the housing. The system utilizes the colder temperature of nearby thermal reservoirs to cool the water and create a suitable environment for cultivating the bivalves so that the bivalve continuously filter the water.

In certain embodiments, the natural body of water is an inlet to an ocean, such as a bay, inlet, cove, gulf, estuary, basin, fjord or the like, that contains saltwater with a sufficient amount of nutrients to feed the oysters and is easily accessible for a land-based farming system. The bay may have average temperatures greater than about 80 degrees Fahrenheit. The relatively warm ocean water is pumped from the bay through the natural thermal reservoir until it is cooled to a suitable temperature for the oysters, preferably at least 10 degrees cooler than the water in the bay, and more preferably about 60 to 68 degrees Fahrenheit.

In one embodiment, the natural thermal reservoir is the earth and the conduit is configured to use the earth as a heat sink. The conduit preferably extends from the inlet below the surface of the earth to the housing and is configured to transfer a sufficient amount of energy from the water to the earth to cool the water to a temperature range suitable for the oysters.

The method may further comprise controlling a volumetric flow rate of the water into the conduit. The volumetric flow rate may be between about 0.005 to 0.50 feet per second, preferably about 0.15 to about 0.20 feet per second.

The method may further comprise delivering oxygen into the water to increase a rate of circulation of the water, thereby providing a constant source of nutrition to the oysters and increasing their filtering capacity

The recitation herein of desirable objects which are met by various embodiments of the present description is not meant to imply or suggest that any or all of these objects are present as essential features, either individually or collectively, in the most general embodiment of the present description or in any of its more specific embodiments.

### BRIEF DESCRIPTION OF THE DRAWINGS

FIG. 1 is a schematic illustration of a marine farming system;

FIG. 2 is a top view of the marine farming system of FIG. 1;

FIG. 3 is a top view of a bivalve housing of the marine farming system of FIG. 1;

FIG. 4A illustrates one embodiment of a container for bivalves;

FIG. 4B illustrates another embodiment of a casing of the bivalve housing of FIG. 3;

FIG. 4C illustrates another embodiment of a casing with a layer of concrete for housing bivalves;

FIG. 5A illustrates an upwelling casing of the marine farming system according to certain embodiments;

FIG. 5B illustrates a downwelling casing of the marine farming system according to certain embodiments;

FIG. 6A is a top view of a fluid delivery system for a marine farming system;

FIG. 6B illustrates a coupling section of the fluid delivery system of FIG. 6A;

FIG. 6C illustrates another embodiment of a coupling section;

FIG. 7A illustrates an auxiliary cooling system for the marine farming system;

FIG. 7B is a side view of the cooling system of FIG. 7A;

FIG. 8A is a top view of a filtering assembly of the marine farming system;

FIG. 8B. is a side view of the filtering assembly of FIG. 7A;

FIG. 8C is a cross-sectional view of one portion of the filtering assembly of FIG. 7A;

FIG. 9A is a top view of another filtering assembly for a marine farming system;

FIG. 9B is a side view of the filtering assembly of FIG. 9A;

FIG. 9C is a front view of the filtering assembly of FIG. 9A;

FIG. 9D illustrates a fastening assembly for the filtering assembly of FIG. 9A;

FIG. 10 is a perspective view of a representative propeller used in a marine farming system; and

FIG. 11 is a side view of a representative tumbling device used in the marine farming system.

### DETAILED DESCRIPTION OF THE EMBODIMENTS

This description and the accompanying drawings illustrate exemplary embodiments and should not be taken as limiting, with the claims defining the scope of the present description including equivalents. Various mechanical, compositional, structural, and operational changes may be made without departing from the scope of this description and the claims, including equivalents. In some instances, well-known structures and techniques have not been shown or described in detail so as not to obscure the decryption. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting. Any molecular weight or molecular mass values are approximate and are provided only for description.

While the following description is presented specifically with respect to filtering water with oysters, it should be appreciated that the systems and methods described herein may be applicable to filtering water with other marine animals and plants, such as other bivalves (e.g., scallops, claims, mollusks and the like), fish, shrimp and other crustaceans, aquatic plants, algae and other water-based organisms.

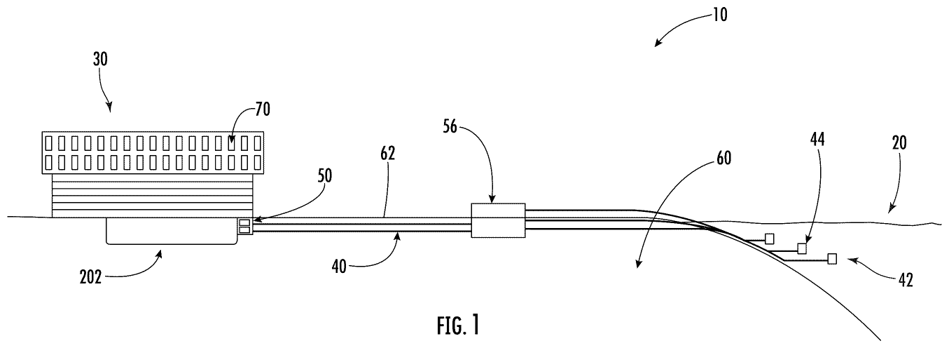

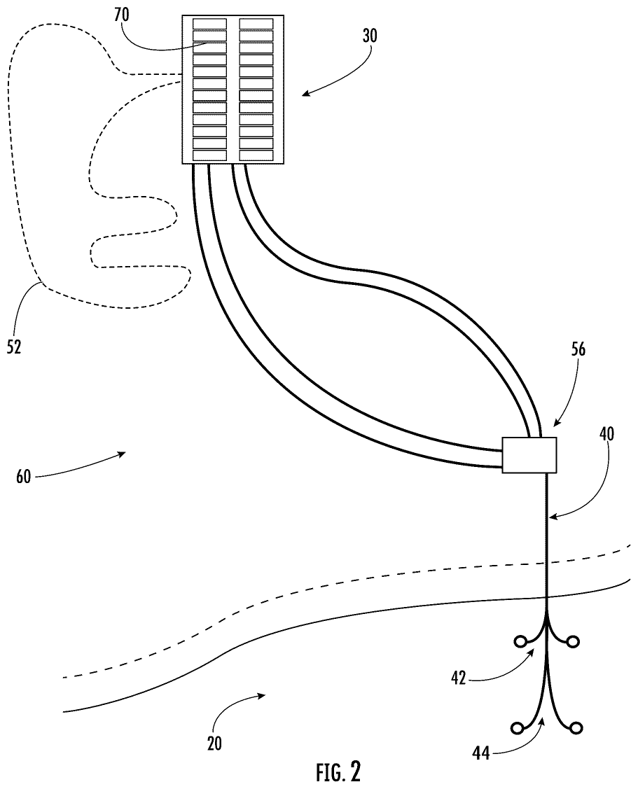

Referring now to FIGS. 1 and 2, a marine farming system 10 is preferably situated adjacent to or near a large body of water, such as an ocean bay 20, estuary, cove, gulf, sound, bight, fjord, or the like, that includes a sufficient amount of nutrients, such as phytoplankton and/or algae that oysters can filter through their gills. In preferred embodiments, the body of water will contain saltwater, e.g., seawater or brackish water, although it should be understood that the methods and devices described herein could also be envisioned for use in freshwater locations, such as lakes or rivers. Oysters may, for example, filter pollutants from the water, remove excess nitrogen from the water and/or remove carbon from the water, which reduces the overall amount of carbon that eventually ends up in the atmosphere.

In an exemplary embodiment, the oysters are triploid oysters. Triploid oysters have been genetically altered using controlled applications, such as heat, pressure or chemicals, so that they are reproductively inactive. Thus, in summer months when oysters are typically spawning, triploid oysters continue to feed (rather than spawn). As a result, triploid oysters typically grow faster, attain a larger size, and have a greater filtering capacity, than standard diploid oysters.

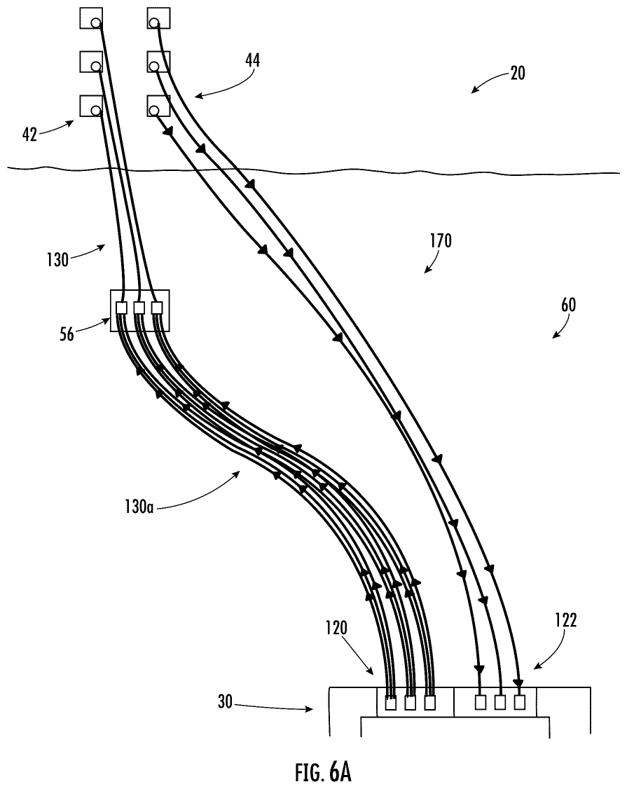

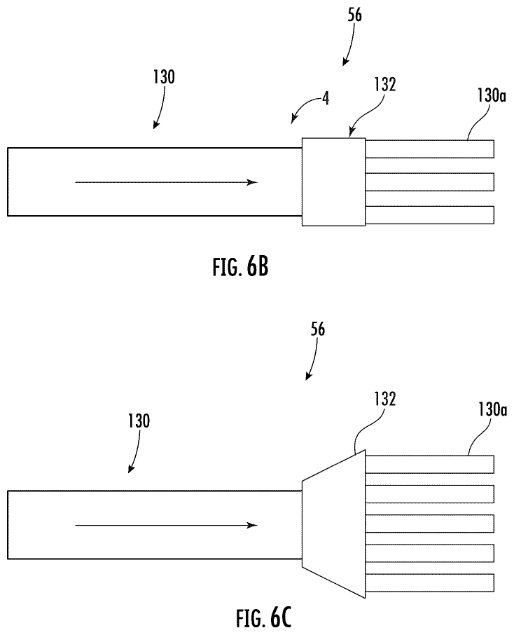

Farming system 10 generally comprises a housing 30 for cultivating and growing the oysters (not shown), a fluid conduit 40 fluidly coupling bay 20 to housing 30 and a pump 50 or other suitable device for moving water from bay 20 through housing 30. Fluid conduit 40 preferably includes one or more inlets 42 and one or more outlets 44 disposed in bay 20 such that the water passing through housing 30 can be recycled back into bay 20. A junction box 56 routes the water into and out of housing 40 (discussed further below in relation to FIGS. 6A-6C).

Fluid conduit 40 passes through a thermal reservoir having a temperature that is lower than the temperature of bay 20. Preferably, the thermal reservoir will be natural and will have sufficient heat capacity to maintain an effectively constant temperature while it is in thermal contact with the farming system. In one embodiment, the large thermal reservoir is the earth 60 and the marine system is configured to use the earth 60 as a heat sink for cooling the water from bay 20. Preferably, fluid conduit 40 passes below the surface 62 of the earth 60, preferably at least one foot below the surface and more preferably at least 2 feet below the surface. The temperature of the earth is approximately 54 degrees F. at this depth, which is below the ideal temperature for cultivating and growing oysters (i.e., about 60 to 68 degrees Fahrenheit).

Of course, it will be understood that other thermal reservoirs or heat sinks can be used. For example, a colder body of water, such as deeper parts of the ocean, a lake, river, glacier or the like, may be used as a natural thermal reservoir.

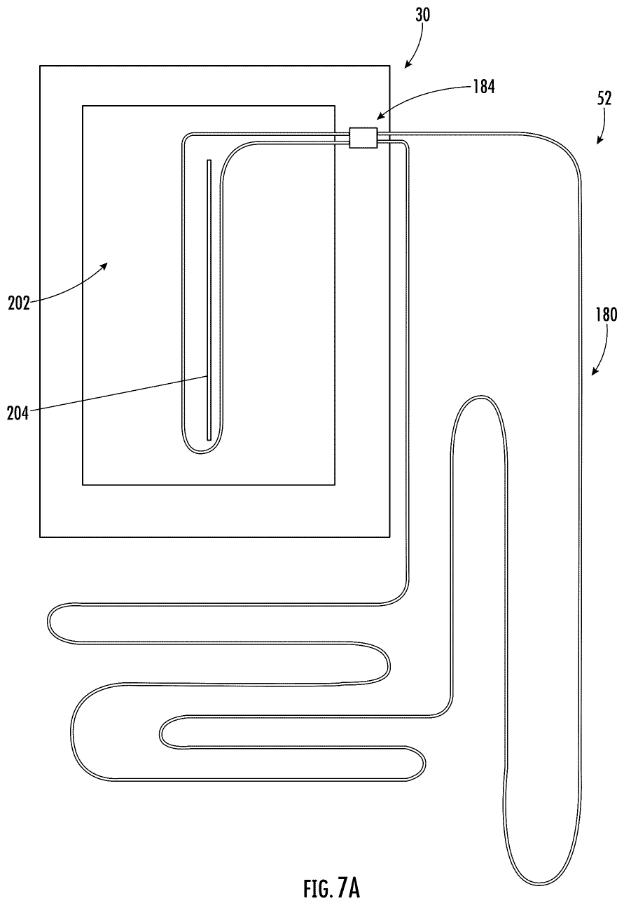

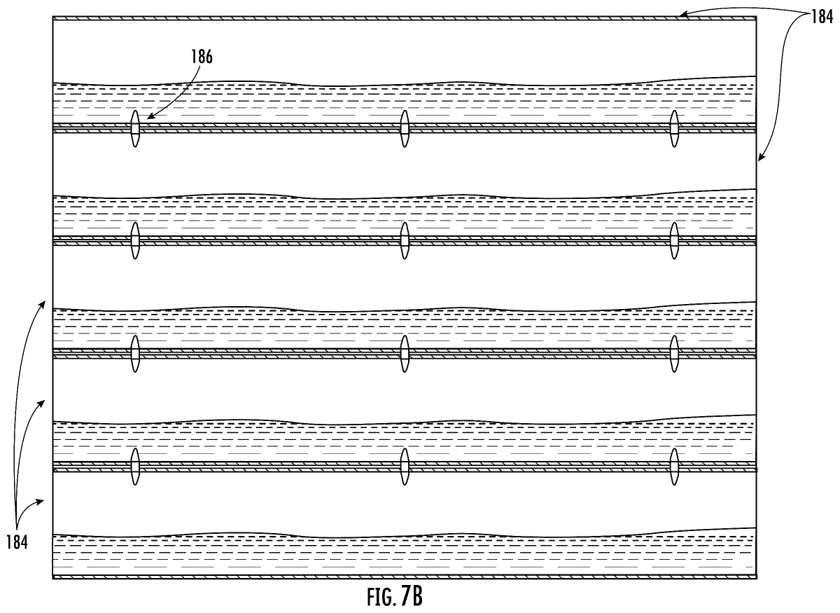

Housing 30 includes a pool 202 of circulating water (discussed in more detail below in reference to FIGS. 7A and 7B) that is preferably at least partially located under the surface 62 of ground 60 to facilitate cooling of the water housed therein. Housing 30 may also include an auxiliary cooling system 52 (discussed below in reference to FIGS. 7A and 7B) for providing additional cooling to a portion of the water in the event that the thermal reservoir does not cool the water to a sufficient temperature along conduit 40. In certain embodiments, housing 30 may also include a plurality of solar panels 70 for providing energy to cooling system 52 and/or pumps 50.

Referring now to FIG. 2, in one embodiment, fluid conduit 40 extends from bay 20 to junction box 56 via pump 50 and then to housing 30 before it returns to bay 20. In the preferred embodiment, fluid conduit 40 has a length between bay 20 and housing 30 that is sufficiently long to allow the earth 60 to cool the water flowing therethrough to the ideal temperature of about 60 to 68 degrees Fahrenheit. In an exemplary embodiment, the water is cooled by at least 10 degrees Fahrenheit. The specific length of conduit 40 will depend on a number of factors, such as the actual temperature of bay 20 (which may be over 80 degrees Fahrenheit), the ideal water temperature within housing 30, the velocity of the water passing through fluid conduit 40, the depth of conduit 40 within the earth 60 and the rate of heat transfer through the outer surface of conduit 40.

Marine system 10 may further include a reheater (not shown) located between housing 30 and outlet(s) 44 to reheat discarded water flowing out of housing 30. This allows the water to be reheated to its original temperature before returning to the bay 20.

Pump 50 may be any suitable mechanism for moving water through conduit 40 by mechanical action, such as direct lift, positive displacement, impulse, velocity, gravity, steam and the like. Pump 50 is preferably designed to provide a variable velocity to the water passing through conduit 40 so that the operator can vary the amount of cooling of the water. Environmental conditions, such as climate or temperature, may change and require a change in the rate of cooling within conduit 40. Alternatively, the oysters may require different ideal temperatures during different stages of their development. In either case, the velocity of the water can be varied to ensure that the temperature arriving at housing 30 is optimal.

Pump 50 may operate via many different energy sources, such as electricity, thermal energy, wind power, solar, etc. In one embodiment, farming system 10 includes a plurality of solar panels 70 extending above and/or around housing 30 and coupled to pump 50 to provide some or all of the energy required to operate pump 50.

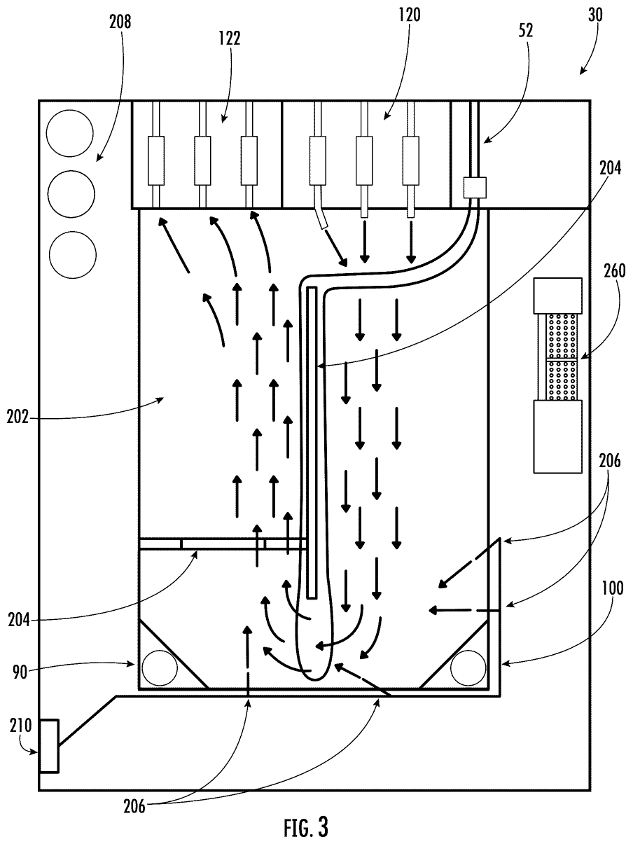

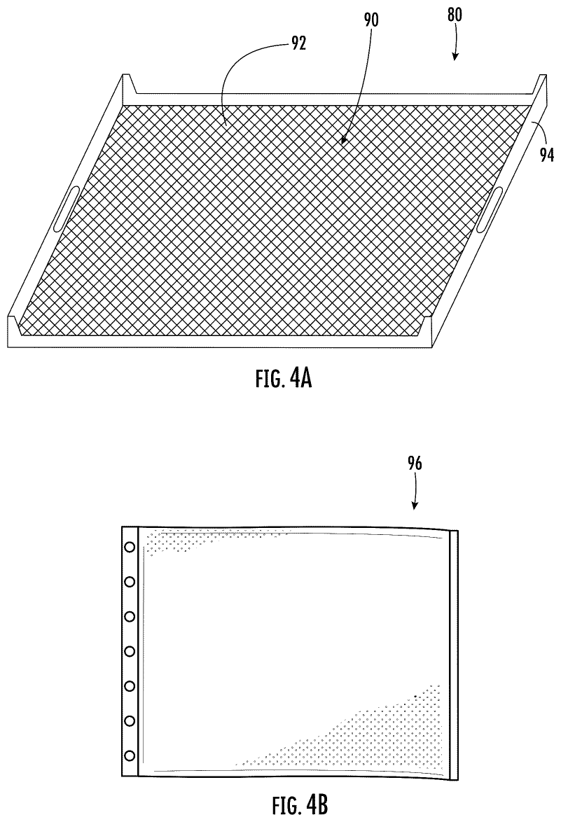

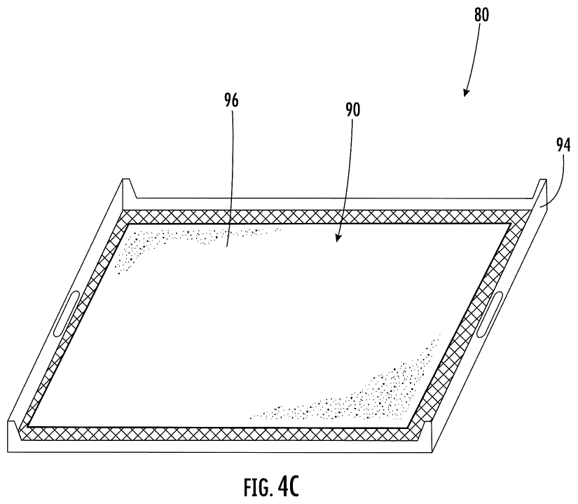

Referring now to FIG. 3, housing 30 preferably comprises a large pool 202 of circulating water with a plurality of cases 80 (see FIG. 4A) stacked vertically upon each other within the pool of water. Each case 80 is preferably sized to house between about 1,000 to 2,000 adult oysters or about 2,000 to 4,000 juvenile oysters. Smaller or juvenile oysters are preferably contained within mesh bags 96 (see FIG. 4B) or another suitable container within cases 80. Of course, it will be understood that other configurations can be used. For example, the cases 80 may be situated side-to-side with each other. Alternatively, the mesh bags 96 may be tethered to the housing and float within the pool of water (i.e., without any casings).

Housing 30 includes a large pool 202 of circulating water with a dividing wall 204 that extends longitudinally through at least a portion of the central axis of pool 202 to provide a circuit for water around dividing wall 204. The water enters pool 202 from a plurality of inlets 120, passes around dividing wall 204 and then exits through one or more outlets 122. Housing 200 preferably comprises one or more propellers 204 locating within pool 202. Propellers 204 are designed to increase circulation of the water in a generally clockwise or counterclockwise direction around dividing wall 204. The circulating water provides a constant source of nutrition to the oysters to allow the oysters to continuously feed and filter the water. In addition, the increased water circulation breaks off the delicate new growth of the juvenile oyster's shell, causing the oyster to put more energy into forming a deep cup, thereby providing more meat content for eating.

Housing 30 may further include at least one downweller 90 and at least one upweller 100 located at the corners of pool 30 (discussed in further detail below). In certain embodiments, the water is pumped through housing 30 such that it passes through cases 80 and both downweller 90 and upweller 100. The deliberate flow of water through the pool allows nutrient-rich ocean water to flow through the casings and result in healthier, plumper and better tasting oysters. The nutrient-rich ocean water also provides increases the feeding capacity of the oysters, thereby increasing the rate in which they filter the water.

Housing 30 may further include one or more inlets 206, preferably located along one or more of the walls of pool 202. Inlets 206 are coupled to conduits 208 that fluidly couple inlets 206 to a source of oxygen (not shown), such as air, pure oxygen or some other gas that contains a sufficient quantity of oxygen. Housing 30 further comprises one or more pumps or compressors 210 configured to pump the oxygen through inlets 206 and into pool 202. The oxygen increases the rate of circulation of the water which provides a constant source of nutrition to the oysters, thereby increasing their filtering capacity. In addition, the increased water circulation breaks off the delicate new growth of the juvenile oyster's shell, causing the oyster to put more energy into forming a deep cup, thereby providing more meat content for eating. In an alternative embodiment, inlets 206 are coupled to another gas that will increase circulation of the water within housing 200, such as helium, nitrogen, argon, neon or the like.

Of course, it will be recognized that other water aeration devices may be used to provide oxygen to the water in pool 202 and increase its circulation. For example, floating or low speed surface aerators, paddlewheel aerators, coarse or fine bubble aerators or similar devices may be used to increase or maintain the oxygen saturation of water within pool 202.

Housing 30 may further include a tumbling device 260 for displacing the oysters within the interior of the water in housing 30 (discussed in more detail below). In certain embodiments, housing 30 may further include one or more grow tanks 208 that include an incubator for juvenile oysters to grow and mature into adults. Young oysters typically require different conditions to grow than adult oysters.

As shown in FIG. 4A, cases 80 generally comprise base 90 for holding the oysters and comprising a plurality of holes or apertures 92 to allow water to pass through base 90. Base 90 preferably have a substantially rectangular surface area of about 30 inches by 36 inches, although it will be recognized that many sizes and shapes may be used. Base 90 is preferably surrounded by a frame 94 that supports base 90 and allows the cases 90 to be stacked on top of each other with little to no space therebetween. This maximizes the amount of oysters that may be housed in one stack of cases 80.

Housing 30 may further comprise a number of spacers (not shown) between each of the cases 80. The spacers serve to provide more space between cases 80 and facilitate loading and unloading of individual cases 80.

As shown in FIG. 4B, juvenile oysters or smaller oysters may be placed within mesh bags 96 disposed on bases 90 of cases 80. Mesh bags 96 are preferably about 18 inches by 24 inches in dimension although it will be recognized that the exact size and shape of mesh bags 96 may be modified to optimize the cost and efficiency of housing smaller oysters.

FIG. 4C illustrates another embodiment that includes a substrate positioned adjacent to, or near, the oysters in housing 30. In one embodiment, the substrate comprises a thin layer 96 of an inorganic material, such as concrete, limestone, chalk or other suitable material that contains calcium carbonate or similar materials that provide constituents to the oysters for growing their shells. As shown, inorganic layers 96 are preferably attached to one, or both, sides of cases 80 such that the oysters in cases 80 can attach to layers 96. Alternatively, the substrate 96 may be disposed within the cases 80. As the oysters grow, they will withdraw calcium carbonate or other suitable materials from layers 96 to grow their shells. This hardens the shells so that they do not break apart when they are shucked.

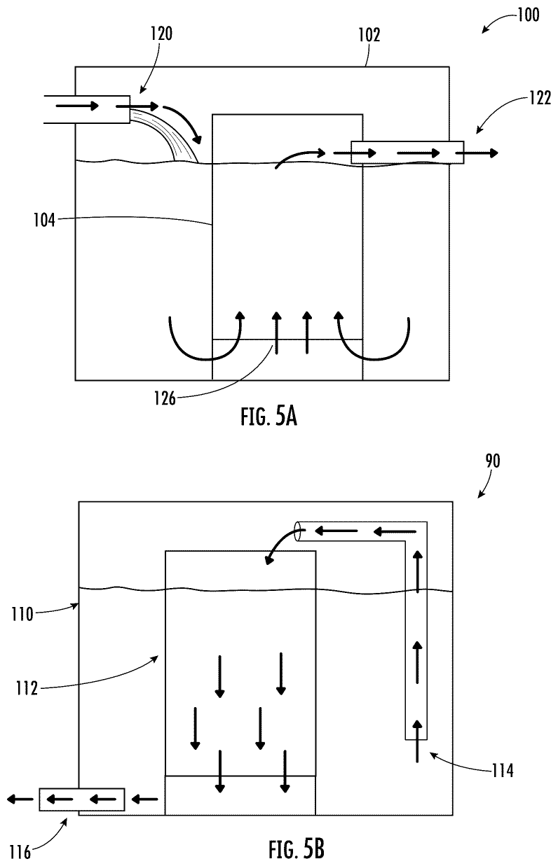

Referring now to FIGS. 5A and 5B, upweller 100 preferably comprises a housing 102 for an open container 104, such as a 55 gallon drum, containing a plurality of oysters. Housing 102 has an inlet 120 and an outlet 122 preferably disposed in the upper portion of upweller 100. Water is pumped through inlet 120 downwards to the bottom of container 104, wherein the water then passes back upwards through holes 126 in the bottom of container 104. The water passes through container 104 and the oysters housed therein until it exits outlet 122.

Downweller 90 comprises a similar housing 110 and container 112 except that the inlet 114 and outlet 116 are preferably disposed in a lower portion of housing 110. Water can be pumped upwards through housing and then back down through one or more openings in the top of container 112. The water may then be pumped through container 112, or it may just displace downwards through the operation of gravity. Juvenile oysters are preferably housed within upweller 100 and downweller 90 until they are large enough to be placed into the mesh bags 96 in casings 80.

Referring now to FIGS. 6A-6C, fluid conduit 40 preferably has a sufficient outer surface area to cool the water flowing therethrough to the ideal temperature before the water reaches housing 30. In one embodiment, fluid conduit 40 includes a plurality of pipes 130 extending from inlet 42 and through the earth 60 to housing 340. Pipes 130 are preferably designed to create the optimal current of water flowing into the pool of water within housing 30. The velocity of the water is preferably selected to ensure that the oysters have sufficient time to absorb nutrients as the water flows through their gills. In certain embodiments, a clockwise or counterclockwise current will be created within the pool to ensure that water flows throughout all of the casing 80 housed therein. Of course, other configurations are possible. For example, cases 80 may be situated in multiple rows or columns throughout the housing, with the water flowing in one direction through a row and then in the reverse direction through an adjacent row. Alternatively, cases 80 may be aligned in a single row or column with the water flowing straight through the housing.

FIG. 6A is an overview of one embodiment of a suitable fluid delivery system 170 for marine farming system 10. As shown, fluid delivery system 170 includes one or more inlets 42 for receiving water from the body of water (e.g., a bay of an ocean) and one or more outlets 44 for discharging the used water back to the body of water. One or more delivery tubes or pipes 130 couple inlets 42 with junction box 56, where the pipes 130 may be routed to housing 30, as discussed above. Pipes 130 comprise a suitable material for conducting thermal energy through their outer surfaces via thermal conduction, such as metal or another suitable thermal conductor (e.g., high density polyethylene (HDPE)).

In certain embodiments (shown in FIGS. 6B and 6C), each pipe 130 is connected to junction box 56 via a pipe fitting 132 that extends the overall cross-sectional area of the conduit, thereby allowing a larger number of pipes 130a to extend from junction box 56. Pipes 130a may be housed within a larger fluid conduit as they pass through the earth 60, or they may be separated such that each pipe 130a is surrounded by the earth 60 to facilitate the transfer of energy from the water to the earth. Pipes 130 preferably have a diameter of about 4 inches between inlet 42 and junction box 58. Pipes 130a extending between junction box 58 and housing 30 preferably have a smaller diameter, e.g., about 2 inches.

Referring now to FIGS. 7A and 7B, marine system 10 may optionally include an auxiliary cooling system 52 for providing additional cooling to water within housing 30. Cooling system 52 is designed to divert at least a portion of the water from inlet 42 (FIG. 1) to provide additional cooling for a portion of the water. Alternatively, cooling system 52 may contain its own supply of water that continuously circulates through system 52. As shown, auxiliary cooling system 52 comprises one or more pipes 180 preferably buried at least 4 feet below the surface of the ground 62. Pipes 180 extend through the ground a sufficient distance to cool the water to optimal temperatures (as discussed above). A pump 184 functions to pump the water through pipes 180 into pool 202.

In one embodiment, pipes 180 pass around dividing wall 204 to provide cooled water in pool 202. The cooled water thermally transfers energy from the water in the rest of the pool, thereby further cooling the water that contains the oysters.

As shown in FIG. 7B, a plurality of cooling lines 184 extend along the center of housing 30 on one or both sides of dividing wall 204. Cooling lines 184 may be fastened to dividing wall 204 and/or each other by any suitable means, such as metal collars 1866, screws, bolts and the like. In a preferred embodiment, cooling lines 184 are stacked on top of each other from the top to the bottom of dividing wall 204. Each cooling line 184 preferably has an outer diameter of about 5 to 15 inches, more preferably about 9 inches. This increases the overall surface area between the cooled water and the rest of the water in pool 202.

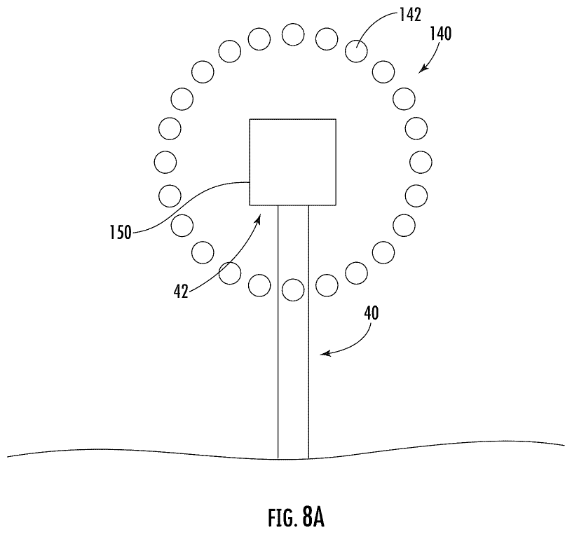

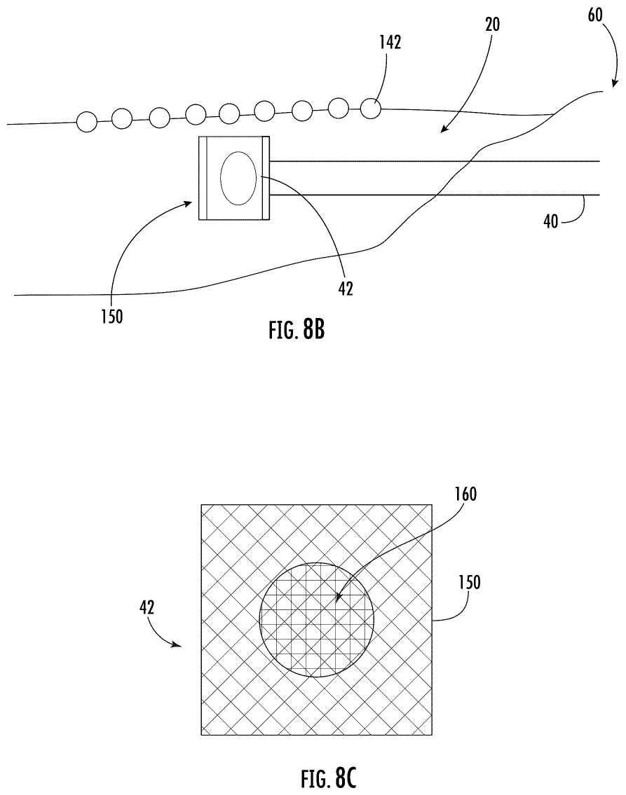

Referring now to FIGS. 8A-8C, marine system 10 preferably includes a filtering system to allow the passage of water and nutrients, while preventing or at least inhibiting the ingress of unwanted animals, plants, seaweed, jellyfish or other ocean debris into system 10. In certain embodiments, the filtering system preferably comprises a plurality of openings having diameters in the range of about 0.05 to about 0.5 inches, more preferably about 0.125 to about 0.25 inches.

In one embodiment, the filtering system includes a boom area net 140 surrounding inlet 42. As shown, boom area net 140 preferably comprises a plurality of floatation devices 142 attached to a net 144 that surround inlet 42. Boom area net 140 can be considered as a first line of defense for filtering larger substances from the area around inlet 42. Filtering system may further include a cap filter 150 coupled to conduit 40 around inlet 42. Cap filter 150 preferably comprises a substantially cubical filter that can be attached to the end of conduit 40 to provide a second line of defense. In addition to, or alternatively, the filtering system may further comprise a mesh lining 160 placed directly across the opening of inlet 42.

Marine system 10 preferably includes a control intake (not shown) coupled to inlet 42 of the fluid distribution system for controlling a volumetric flow rate of the water into conduit 40. This ensures that the system intakes a controlled volume of water from the natural body of water (e.g., an inlet to an ocean), thereby ensuring that the system is environmentally friendly and complies with relevant regulatory requirements. In an exemplary embodiment, the volumetric flow rate into conduit 40 is between about 0.005 to 0.50 feet per second, preferably about 0.15 to about 0.20 feet per second.

In certain embodiments, the control intake comprises a cage substantially surrounding the inlet of the conduit. The cage may include one or more filters configured to control the volumetric flow rate of the water into the conduit. The filters may include any suitable water filtration devices, such as mesh screens, or the like.

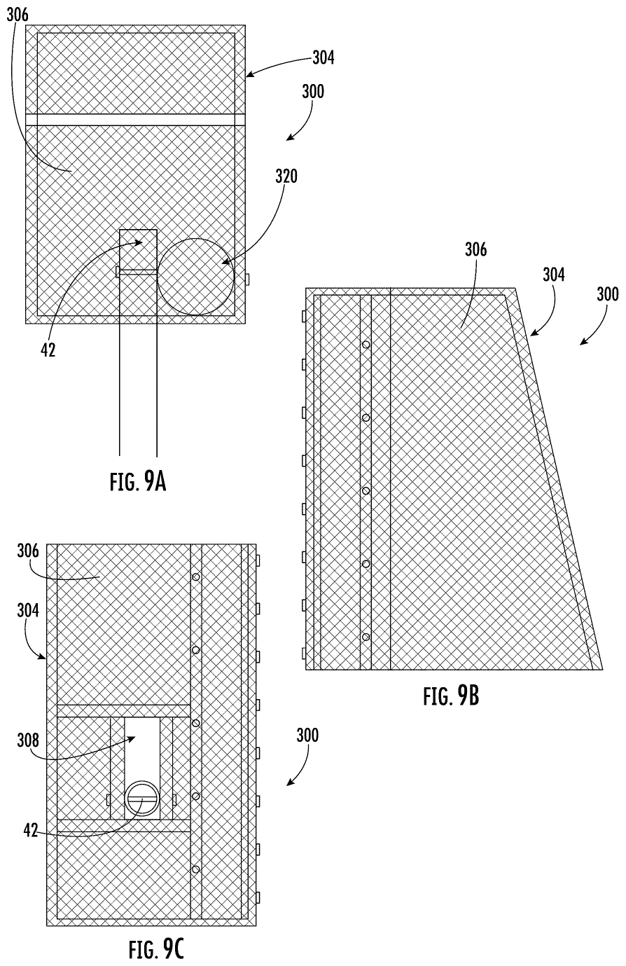

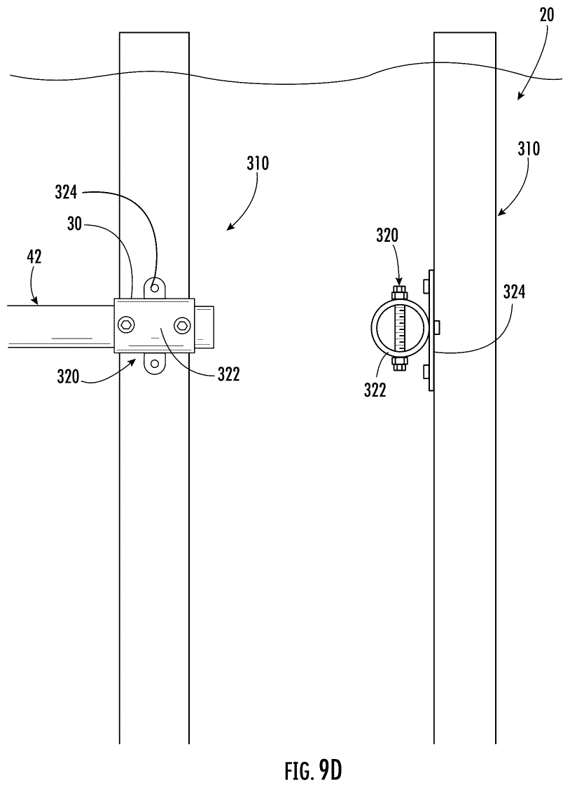

FIGS. 9A-9D illustrate another embodiment of a filtering system 300 for preventing or at least inhibiting the ingress of unwanted animals, plants, seaweed, jellyfish or other ocean debris into system 10. As shown, filtering system 300 includes a housing 302 surrounding inlet 42 and mounted by a fastener 320 to a post or piling (not shown) that has been driven into the ground at the bottom surface of the body of water. Housing 302 includes a frame 304 for holding one or more mesh screens, nets or other filters 306 such that inlet 42 is almost completely surrounded by nets 306. Nets 306 have very small openings 312 that allow water to pass through, inhibiting the ingress of unwanted animals, plants, seaweed, jellyfish or other ocean debris. The filters or mesh screens may, for example, be attached to pilings in the ocean to anchor the entire inlet and control intake system. Housing 302 has an opening 308 directly in front of inlet 42 to allow water to pass freely into inlet 42.

FIG. 9D illustrates a fastener 320 for attaching inlet 42 of conduit 40 to piling 310. As shown, fastener 320 preferably comprises a collar 322 substantially surrounding a distal end portion of inlet 42 for anchoring conduit 40 to piling 310 within the body of water. Collar 322 may be anchored to conduit 40 and piling 310 with lag screws 324 or other suitable fastening devices.

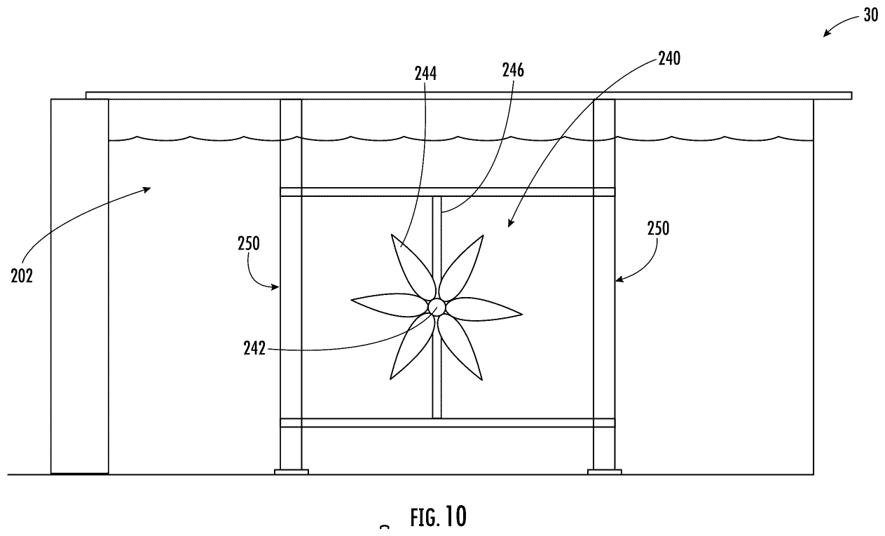

FIG. 10 illustrates a representative propeller 240 that includes a rotating hub 242 a plurality of radiating blades 244 that are set at a pitch to form a helical spiral, thereby transforming rotational power into linear thrust by acting on the water within pool 202. Of course, it should be recognized that other suitable propellers known by those skilled in the art may be used, such as tubeaxial, vaneaxial, centrifugal, radial or crossflow fans and the like. Propeller 240 is preferably anchored to housing 30 within pool 202 by a central post 246 that extends substantially vertically and attaches to upper and lower horizontal posts 248. The horizontal posts 248 are attached to separate posts or pilings 250 within pool 202 to anchor propeller 240 within pool 202 without interfering with the motion of blades 244. Alternatively, horizontal posts 248 may be directly attached to dividing wall 204 and/or the outer wall of pool 202.

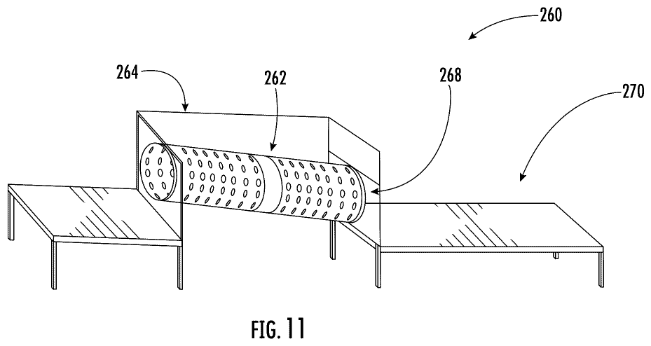

Referring now to FIG. 11, marine system 10 may further include a tumbling device 260 for displacing the oysters within the interior of the water in pool 202. Alternatively, tumbling device 260 may be located within housing 30 exterior to the water in pool 202. The tumbling device jumbles and/or agitates the oysters as they grow, which strengthens their shells. In addition, applicant has found that tumbling the oysters drastically improves their shape making them more attractive and increasing the size of their cups, which increases the meat content.

The tumbling device may comprise any suitable mechanism for displacing the oysters within their containers. In one such embodiment, tumbling device 260 includes a substantially cylindrical enclosure 262 rotatably coupled to a base 264 or other suitable anchoring device. A motor (not shown) or other suitable source of power is configured to rotate enclosure 262 about its longitudinal axis. The oysters are preferably loaded from a sorting table 270 through an opening 268 within enclosure 262, which is then rotated to displace the oysters therein.

Tumbling device 260 may be placed within housing 200, or it may reside exterior to housing 200, as shown in FIG. 3. In certain embodiments, the oysters are housed within a plurality of casings stacked on top of each other within the interior of the housing. Tumbling device 260 is configured to displace the casings sufficiently to agitate the oysters housed therein. In other embodiments, the oysters are periodically moved into tumbling device 260 and then returned to their casings.

Applicant has discovered that oysters produced according to the processes described herein have larger cup sizes than conventional farmed-raised oysters. Restaurants prefer oysters that have strong shells, easy to find hinges, beautiful shapes for presentation, and of course, deep cups filled with meat. Typical cup sizes for natural oysters may range from 3 to 5 inches, whereas farm-raised oysters are typically in the range from about 1 to 3 inches.

In certain embodiments, oysters produced by the processes described herein have cup sizes with volumes from about 3 to 5 inches. This increases the volume of meat within each oyster.

Applicant has further discovered that oysters produced with the processes described herein have harder shells. Typical natural oysters may have a shell hardness in the range of about 1 to 2 GPa and typical farm-raised oysters have shells with hardnesses of about 0.5 to 1.0 GPa. Oysters produced according to the processes described herein have shells with hardness of about 1.0 to 2.0 GPa.

Oysters produced according to the processes described herein typically have a fat content of about 1 to 8 grams, preferably about 2 to 4 grams.

Applicant has also discovered that the processes described herein increase the size of the adductor muscles in oysters, which increases their meat content. In certain embodiments, oysters have adductor muscles with a volume in the range of about 10 to 20 ml, preferably about 13 to 15 grams.

In addition, applicant has discovered that the processes described herein increase the growth rate of oysters, which allows them to be raised to adults in a shorter period of time than conventional farm-raised oysters. This decreases the cost associated with growing the oysters and increases the throughput of the oyster farm. In certain embodiments, oysters described herein typically grow about 0.10 to about 0.30 inches per month, preferably about 0.15 to 0.20 inches per month.

While devices and methods have been described in detail herein in accordance with certain preferred embodiments thereof, many modifications and changes therein may be effected by those skilled in the art. Accordingly, the foregoing described should not be construed to be limited thereby but should be construed to include such aforementioned obvious variations and be limited only by the spirit and scope of the following claims.

What is claimed is:

1. A system for filtering water comprising:
a housing having an interior configured for containing a plurality of bivalves within a fluid;
a fluid distribution system coupled to the housing and configured to circulate water within the interior of the housing; and
wherein the fluid distribution system is configured to circulate the water through the bivalves such that the water is filtered by the bivalves at a rate of about 10 to about 100 gallons of water per day per bivalve.

2. The system of claim 1, further comprising a temperature control coupled to the housing and configured to maintain a temperature of the water within a predetermined range.

3. The system of claim 2, wherein the temperature is about 60 degrees Fahrenheit to about 68 degrees Fahrenheit.

4. The system of claim 1, further comprising a control intake coupled to the inlet of the fluid distribution system for controlling a volumetric flow rate of the water into the conduit, wherein the volumetric flow rate is between about 0.15 and 0.20 feet per second.

5. The system of claim 1, further comprising an oxygen delivery system coupled to the interior of the housing and configured to deliver oxygen into the fluid, wherein the oxygen delivery system delivers a sufficient amount of oxygen into the interior of the housing to increase a rate of circulation of the fluid.

6. The system of claim 5, wherein the oxygen delivery system comprises a pump coupled to a source of air, and a conduit fluidly coupling the source of air with the interior of the housing.

7. The system of claim 1, wherein the fluid distribution system includes one or more propellers disposed within the interior of the housing.

8. The system of claim 1, further comprising a dividing wall extending through at least a portion of the interior of the housing, wherein the fluid distribution system is configured to circulate the water around the dividing wall.

9. The system of claim 1, further comprising a tumbling device for displacing the bivalves within the interior of the housing.

10. The system of claim 1, further comprising a substrate disposed within the interior of the housing adjacent to or near the bivalves, the substrate having a surface comprising an inorganic surface.

11. The system of claim 1, wherein the bivalves comprise oysters and the water is filtered by the oysters at a rate of about 40 to about 60 gallons of water per day per oyster.

12. The system of claim 11, wherein the oysters filter materials from the water, the materials comprising one of sediment, nitrogen, phosphorus, carbon, magnesium or zinc.

13. The system of claim 2, wherein the fluid distribution system comprises an inlet coupled to a body of water and a conduit in thermal contact with a thermal reservoir having a temperature cooler than the body of water, the fluid distribution system being configured to move the water from the body of water to the interior of the housing and to cool the water such that a temperature of the water is substantially reduced between the body of water and the housing.

14. The system of claim 13, further comprising an outlet coupling the interior of the housing with the body of water such that filtered water passes from the housing to the body of water.

15. A method for filtering water comprising:
positioning a plurality of bivalves within an interior of a housing; and
circulating water through the bivalves such that the water is filtered by the bivalves at a rate of about 10 to about 100 gallons of water per day per oyster.

16. The method of claim 15, further comprising maintaining a temperature of the water within the housing within a predetermined range of about 60 degrees Fahrenheit to about 68 degrees Fahrenheit.

17. The method of claim 15, further comprising controlling a volumetric flow rate of the water into the conduit between about 0.15 and 0.20 feet per second.

18. The method of claim 15, further comprising delivering oxygen into the water to increase a rate of circulation of the water.

19. The method of claim 15, further comprising:
circulating the water around a dividing wall within the housing;
withdrawing the water from a body of water; and
circulating the water adjacent to, or in contact with, a thermal reservoir having a temperature cooler than the body of water to cool the water such that a temperature of the water is substantially reduced between the body of water and the housing.

20. The method of claim 15, wherein the bivalves comprise oysters and the water is filtered by the oysters at a rate of about 40 to about 60 gallons of water per day per oyster.
